(19) United States
(12) Patent Application Publication
(10) Pub. No.: US 2026/0356034 A1
(43) Pub. Date: Nov. 12, 2026

(54) OBJECT MANIPULATION AND TRANSFER BY PROPULSION

(71) Applicant: Poietis Biosystems, Pessac (FR)

(72) Inventors: Antonio Iazzolino, Pessac (FR); Bertrand Viellerobe, Merignac (FR); Fabien Guillemot, Preignac (FR)

(21) Appl. No.: 19/120,951

(22) PCT Filed: Oct. 20, 2023
(86) PCT No.: PCT/EP2023/079252

§ 371 Date: Apr. 14, 2025

(30) Foreign Application Priority Data
Oct. 20, 2022 (FR) 2210885

(51) Int. Cl. B29C 64/141; B29C 64/273; B29C 64/282; B29C 64/393; B29L 31/00; B33Y 10/00; B33Y 30/00; B33Y 50/02; B33Y 80/00

(52) U.S. Cl. CPC B29C 64/141; B29C 64/273; B29C 64/282; B29C 64/393; B33Y 10/00; B33Y 30/00; B33Y 50/02; B33Y 80/00; B29L 2031/753

(57) ABSTRACT

A method for transferring at least one object from a film of carrier liquid having a thickness e_{z} on a surface of a donor substrate toward a target substrate, in a vertical direction Z, the carrier liquid containing the at least one object to be transferred, the at least one object having dimensions (Dₓ, D_{y}, D_{z}), the method including exciting the liquid by applying localized energy to the liquid to form a local cavitation bubble at the at least one object, wherein the ratio D_{z}/e_{z} is greater than 0.5. A system may be used to perform such a method.

### CROSS-REFERENCE TO RELATED APPLICATIONS

This application is a national phase entry under 35 U.S.C. § 371 of International Patent Application PCT/EP2023/079252, filed Oct. 20, 2023, designating the United States of America and published as International Patent Publication WO 2024/084030 A1 on Apr. 25, 2024, which claims the benefit under Article 8 of the Patent Cooperation Treaty of French Patent Application Serial No. FR2210885, filed Oct. 20, 2022.

### TECHNICAL FIELD

The present disclosure relates to the field of additive manufacturing of a material by repeated transfers of particles between a donor substrate and a receiving substrate, a film of carrier liquid containing the particles to be transferred being deposited on the donor substrate, and, in particular, to the field of bioprinting. The specific field of bioprinting relates to the use of digital manufacturing methods to organize and assemble biological tissue components in 2D and 3D, with the aim of producing grafts for regenerative medicine or physiological models for biomedical and pharmaceutical research.

### BACKGROUND

The general principle of the present disclosure is to transfer biological (e.g., cells), organic, or inorganic objects from a carrier liquid deposited on a substrate in the form of a film, and to deliver an energy pulse to form a cavitation bubble, either directly by vaporization of the liquid portion in the focal field of the energy source-usually a laser-or via a thin metal coating forming a sacrificial layer on the donor substrate. This cavitation bubble carries the particle(s) in the targeting axis toward a receiving substrate, on which the transferred particles accumulate as the pulses are repeated.

In the state of the art, U.S. Patent Application Publication No. US2020/009877 is known, which describes an apparatus for depositing particles on a target from a transparent slide carrying a film that is formed by a fluid containing particles in suspension, by locally exciting the film using a laser beam directed by a controlled optical deflection means, the apparatus comprising means for observing the local activation region by an optical imaging system including a sensor and a lighting source, the optical axes of which are substantially aligned in the part between an optical splitter and the film. The optical beam of the imaging system and the optical beam of the laser are coaxial in the part between the controlled optical deflection means and the film.

The apparatus comprises a first focusing optical unit located between the controlled optical deflection means and the film, and a second image conjugation optical unit located between the sensor and the separator. The sensor is positioned in the focal plane of this second optical unit.

Chinese Patent Publication CN113021874 describes a single-cell printing method based on the transfer induced by an annular laser spot, which comprises the following steps:
step 1, after pulsed laser beams that are uniformly distributed are incident on an element of the annular light spot forming system, the emerging light is focused to form an annular light spot on a sacrificial layer through a transparent stress layer;
step 2, the sacrificial layer is ablated by laser light and heat to form an annular plasma cavitation bubble;
step 3, rapid expansion of the annular cavitation bubbles and removal of the cell solution outside the rings, and parallel downward thrust of the target transfer cells in the center of the rings under the expansion of the cavitation bubbles;
step 4, collapse of the annular cavitation bubbles and complete expulsion of the target transfer cells by collapse of the shock waves generated in the vertical direction with respect to the central position of the ring;
step 5, under the action of gravity and self-generated impulse, printing of the target transfer cells and the transported solution onto a receiving plate.

U.S. Patent Application Publication No. US2022152925 describes a printing method using a piece of equipment comprising an energy-delivering exciter that is orientable to produce a punctiform interaction with at least one ink that possibly contains non-uniformities and that is deposited on a printing medium including a transparent interaction area, in order to cause the transfer of a targeted portion of the ink to a receiver, the method including generating a wetting film at least partially covering the transparent interaction area, followed by depositing the ink on the surface of the wetting film and transferring steps.

U.S. Patent Application Publication No. US2020102529 relates to equipment and a method for additive manufacturing, comprising an orientable energy excitation means for generating an intermittent interaction with a fluid covering a blade in order to trigger a jet oriented in the direction of a target, the fluid consisting of a liquid vector containing inhomogeneities, wherein: the fluid forms a liquid film with a thickness measuring less than 500 μm on a blade having at least one area allowing the interaction with the laser, into which at least one inlet leads, the interaction area leading into at least one outlet, the equipment also comprising means for the circulation of the fluid between the inlet and the outlet.

U.S. Patent Application Publication No. US2017225390 relates to a method of additive manufacturing of a three-dimensional object. The method comprises sequentially forming a plurality of layers each patterned according to the shape of a cross section of the object. In some embodiments, the formation of at least one of the layers comprises performing a raster scan to dispense at least a first building material composition, and a vector scan to dispense at least a second building material composition. The vector scan is optionally along a path selected to form at least one structure selected from the group consisting of (i) an elongated structure, (ii) a boundary structure at least partially surrounding an area filled with the first building material, and (iii) an inter-layer connecting structure.

Prior art solutions are suitable for transferring small particles of dimensions significantly smaller than the thickness of the carrier liquid film when based on LIFT, or suitable for handling/transferring large particles by contact when using non-LIFT technologies such as Kenzan or suction. However, they have several drawbacks.

Firstly, the focus of each pulse must be adjusted to take account of the plane wherein the particle in the target area is positioned, to bring the appropriate energy to the plane just below the particle, so that the energy impulse ensures cavitation of the liquid beneath the particle. This step of adjusting the focus before each pulse slows down cadence considerably.

Secondly, the transfer of the particle is accompanied by the transfer of a non-negligible proportion of the carrier liquid, resulting in a material with a low bulk density.

Thirdly, the particles are relatively mobile in the carrier liquid film, and the accuracy of the pulse is affected by the displacements between the time of analysis of the target area image, and the triggering of the pulse.

### BRIEF SUMMARY

In order to address these drawbacks, the present disclosure relates, in its most general sense, to a method for manufacturing a material.

A method of manufacturing by transferring at least one object, in particular, a particle, from a donor substrate to a target substrate, according to the present disclosure, notably provides a donor substrate forming a surface on which a film of carrier liquid of thickness e_{z} is deposited in a vertical direction Z. A liquid vector contains the objects to be transferred with dimensions (Dₓ, D_{y}, D_{z}). Transfer is achieved by local energy excitation of the liquid to form a local cavitation bubble at an object, wherein the D_{z}/e_{z} ratio is greater than 1, and preferably greater than 0.5.

According to one variant, the objects are spheroids made up of an aggregation of elementary biological cells.

Advantageously, the Dₓ, D_{y}, D_{z} values are greater than 100 μm and preferably greater than 200 μm.

According to a second variant, the energy excitation is achieved by focusing a laser at the interface between the surface of the substrate and the carrier liquid film.

According to a second variant, the energy excitation is performed by applying an electric field.

According to a third variant, energy deposition is achieved by focusing an acoustic wave at the interface between the surface of the substrate and the carrier liquid film.

Advantageously, the energy level applied to each pulse is based on the size of the object located in the targeting axis.

According to one variant, the receiving substrate is elastically deformable along the Z axis.

According to a particular embodiment, the method comprises the steps of moving an object in the XOY plane by applying a pulse with an energy at least 2 times lower than the energy required for transferring the object to the receiving substrate.

Advantageously, the objects to be transferred are spaced apart by a characteristic distance (d) of value d >0.5D_{xy}.

According to one embodiment, the objects are biological in nature, including cell aggregates, spheroids, organoids, explants, explants (islets of Langherans), cell-encapsulating polymer particles (biomaterial-coated organoid), cell-seeded microcarriers, and/or biomaterial beads.

Preferably, the volume fraction or density of the biological objects transferred by propulsion within the printed tissue or organ is greater than 30%.

According to a variant, the transfer is repeated to manufacture a material, tissue or organ, and the volume fraction or volume density of the biological objects transferred by propulsion in the printed material, tissue or organ is greater than 30%.

According to another variant, the method is combined with other printing technologies such as extrusion, inkjet, and/or LIFT to produce complex materials or tissues with different components.

According to another variant, the method is carried out using several laser beams simultaneously when the object has a non-isotropic shape, in order to guarantee its transfer along a homogeneous trajectory.

The present disclosure also relates to a system for handling and transferring pulsed energy by deposition, comprising:
an energy source directed at the material to be transferred,
a donor substrate from which the material is manipulated and transferred by energy impulses, and
a target receiving substrate that collects the transferred material.

The donor substrate comprises a slide covered by the material to be transferred, consisting of a liquid carrier film intended to contain transferable objects of size DxDyDz, wherein;
the transferable objects have an orientation Dx, Dy in the plane of the film and Dz perpendicular to the film; and
the ratio between the dimension (Dz) of the object and the thickness (e) of the liquid film is greater than 1 and preferably greater than 0.5.

Preferably, the energy source is a laser.

According to one variant, the donor substrate slide is transparent or has low absorption at the wavelength of the laser beam.

According to a particular embodiment, the system includes an opto-mechanical system for directing the laser spot with respect to the object's centroid or center of mass.

If the object has a particular, non-isotropic shape, the system can allow the simultaneous use of several laser beams directed at different points on the object, in order to detach it evenly.

According to a first variant, the energy source consists of an electric field generator.

According to a second variant, the energy source consists of an acoustic wave generator.

According to one variant, the system includes a system for controlling and servo-controlling the amount of energy deposited based on the size of the particle to be transferred.

Advantageously, the system incorporates an intelligent object detection system, and means for automating the steps of placing the material on the donor substrate and the handling/transfer steps.

According to one variant, the donor substrate is covered by a sacrificial layer with high absorption/conduction properties for laser or electric field energy deposition.

According to one embodiment, the receiving substrate is not covered by a layer with high absorption properties, which is produced directly in the liquid.

According to one embodiment, the system includes an optical viewing/detection system for locating and targeting the objects to be transferred, compatible with a random distribution of objects on the donor substrate.

Preferably, the donor substrate is arranged below the receiving substrate.

According to another embodiment, the system includes at least one other printing means comprising extrusion, inkjet, and/or LIFT to manufacture complex materials or tissues with different components.

According to another variant, the system includes means for delivering several laser beams simultaneously to the object when the object has a non-isotropic shape in order to guarantee transfer of the object along a homogeneous trajectory.

According to one variant, the system includes a system for controlling and servo-controlling the amount of energy deposited based on the size or shape of the object to be transferred, this energy being deposited in the form of a single pulse, several pulses repeated over time on the same point, or several pulses sent simultaneously in an XY pattern linked to the shape of the object.

According to one variant, the receiving substrate is not covered by a layer with high laser absorption properties to initiate the propulsion process, absorption being achieved directly by the liquid layer between the object and the donor substrate.

According to another variant, the donor substrate includes micro-wells wherein the objects to be transferred are arranged.

### BRIEF DESCRIPTION OF THE DRAWINGS

The present disclosure will be better understood on reading the following description, which concerns a non-limiting exemplary embodiment that is shown by the appended drawings, in which:

FIG. 1 shows a schematic view of the transfer system;

FIG. 2 shows an example chronology of the various TRI components for taking an image of the jet at time T;

FIG. 3 shows an exploded view of an example donor substrate; and

FIG. 4 shows a perspective view of an example fluid connector.

### DETAILED DESCRIPTION

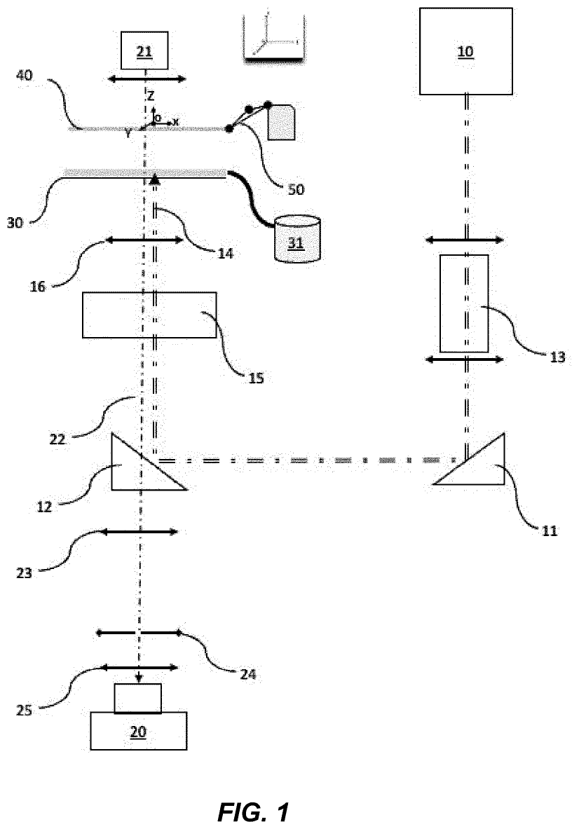

Referring to FIG. 1, the transfer system includes several parts:
an optical part comprising a pulsed laser (10) for generating the cavitation energy of the carrier liquid, and a camera (20) for observing the donor substrate (30) and the receiving substrate (40);
an automated section, with a robot arm (50) used to automate handling of the receiver (40);
a microfluidic device (31) for supplying the donor substrate (30) with the carrier liquid and the particles to be transferred;

and optionally, the system can include an extruder for adding a bond, e.g., a hydrogel-type biomaterial, to the receiving substrate (40) between the transferred particle layers.

More generally, the equipment can combine several 3D printing, bioprinting and photopolymerization technologies.

The optical part of the device is made up of two parts, one part comprising the camera (20) for aiming at objects, and one part comprising the laser (10) used to “pulse,” that is, delivering energy pulses in a plane of the donor substrate (30) where a particle to be transferred is located.

The laser (10) is an Nd-YAG laser, for example, which emits pulses of 1 to 10 ns at 1064 nm with an energy of 15 to 60 microjoules, significantly higher than the energy normally used for LIFT methods.

Another example is a pulsed Ytterbium fiber laser emitting at 1030 nm, with shorter pulses, from 350 femtoseconds to 10 picoseconds, with several tens of microjoules of energy per pulse.

The lens (16) is typically an F-Theta lens with a focal length of 100 mm, suitable for laser scanning. Typical spot size at the focal plane is around 30 to 35 μm in diameter.

The laser beam (14) passes through shaping optics (13) and is then directed via a set of mirrors (11, 12) to a scanner (15), which then sends the beam vertically to the donor substrate (30), via the F-Theta lens (16).

The scanner (15) comprises two automated mirrors that redirect the beam horizontally at an angle toward the objective (16). The objective (16) will then straighten and focus the beam (14) so that it arrives perpendicular to the donor substrate (30). The mirrors of the scanner (15) control the movement of the laser beam (14) along horizontal axes on the donor substrate (30). The laser beam (14) is therefore focused on the donor substrate (30) and steerable along the X and Y axes defining the horizontal plane.

For a donor substrate (30), the beam (14) is focused on the sacrificial layer coating the substrate surface, for example, a 20 nanometer gold layer deposited on a transparent optical window.

The second optical part comprising the camera (20) is the aiming part. Indeed, in the case of the present disclosure, particles are relatively large objects, for example, spheroids formed by an aggregate of cells, with a diameter of more than 100 μm, typically 200 μm to 300 μm. These objects are randomly distributed on the donor substrate (30), so it is necessary to know the position and size of the objects in order to target them with a laser pulse. To achieve this, a visible light source, typically an LED (21), is placed above the cartridge, and the light beam (22) passes through the scanner (15) following the reverse path of the laser beam. It then arrives at a semi-reflective mirror (12), which lets visible light through to the camera (20), but reflects infrared light back to the laser (10). The beam then passes through a lens (23), an iris (24) and an objective (25) before arriving at the camera (20). Everything is aligned so that the laser beam (14) focuses on the center of the image retrieved by the camera (20).

### Nature of Items Transferred

The system implemented by the present disclosure is similar to a system designed for LIFT bioprinting, with the difference that the impulse energy is at least 2 or even 5 times greater, and that the placement of the objects to be transferred differs fundamentally from the solutions used for LIFT bioprinting, where the particles to be transferred form a bioink where the particle sizes are much smaller than the thickness of the film deposited on the donor substrate (30).

In the context of the present disclosure, the objects have a size of more than 100 μm, typically 200 to 400 μm or more, and are positioned in a liquid, typically water with salts added to adjust the density, or a 2% BSA (Bovine Serum Albumin) solution, forming a film with a thickness less than the size of the particles to be transferred, so that the donor substrate (30) no longer receives a bio-ink, but particles rest partially in an aqueous film that does not cover them completely.

The present disclosure relates in a non-limiting way to the transfer of spheroids formed by the aggregation of cells cultivated in the laboratory and presenting the appearance of a small pearl made of cells and extra-cellular matrix.

In order to produce spheroids, stem, progenitor or differentiated cells are cultured by conventional methods and seeded in microwells to produce aggregates, which are then manipulated according to the method of the present disclosure.

### Pulse Sequences

The LIFT phenomenon is a process that takes place over very short times, of the order of a hundred microseconds, and can be observed by a TRI device.

TRI (Time Resolved Imaging) involves taking images of a phenomenon at a specific time by synchronizing a camera with the laser (10) and an LED to take a picture at a precise moment in the jet. The three components are synchronized via an electronic board to precisely control the activation of the various components over time. To obtain an image of the jet at a precise instant, the camera is switched on for several hundred microseconds, while the LED emits only a 2 μs flash of light at the desired instant. The LED is positioned in front of the camera, so as to illuminate the jet.

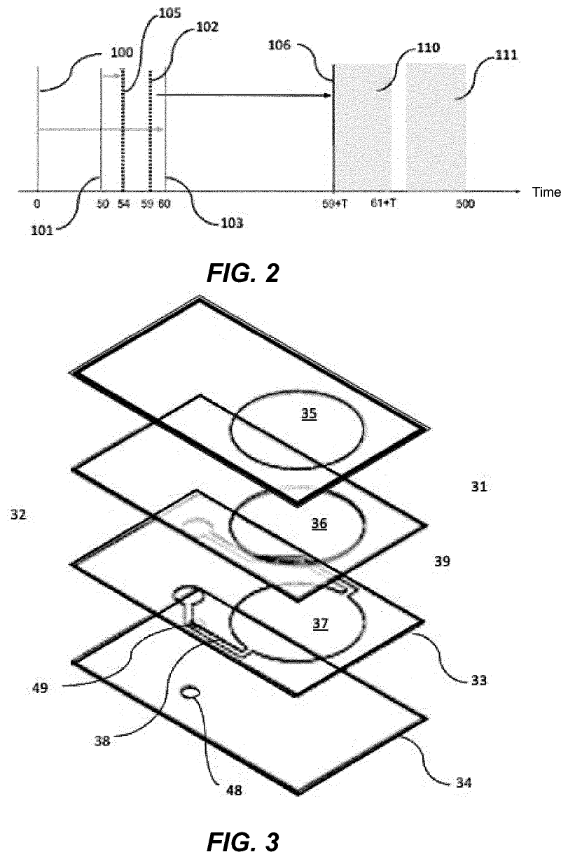

FIG. 2 shows the TRI chronology with a time scale in microseconds. The first step (100) is to switch on the analyzer camera, which takes 60 μs to light up. The laser (10) takes 4 μs to light up (105), and a further 5 μs to perform the laser pulse. If the camera is switched on when the during the laser pulse, the beam will be visible on the image, making it less legible; the pulse must therefore be done before the analyzer camera is switched on.

The laser (10) is therefore switched on (101) 50 μs after the scanner camera, so that pulse (102) takes place at 59 μs, that is, 1 μs before the scanner camera is switched on (103). The camera then remains on for 500 μs. Finally, the LED will emit a sequence of 2 μs light flashes (110, 111) starting at the desired time (106), T μs after the laser pulse, that is, 59+T μs after the camera is switched on, to create a stroboscopic image with 2 μs time intervals between two flashes.

The images thus obtained show a very different particle behavior from that observed in the state of the art with LIFT bioprinting. The large particle is propelled without taking any of the carrier liquid with it, by forming a cavity bubble in the liquid film at the interface between the particle and the substrate bottom, rather than on a volume enveloping the particle. As the particle emerges from the liquid film, it pushes aside the surrounding liquid to emerge directly from the carrier liquid and reach the receiving substrate with very little liquid carried along.

### Donor Substrate

FIG. 3 shows an exploded view of a donor substrate (30) receiving the film of technical liquid and the ink containing the particles to be transferred, spread on a cartridge, which serves as a support for laser pulses. It is composed of an assembly of four stages (31, 32, 33, 34) of glass and PDMS. The purpose of the technical liquid is to clean the central area of the donor substrate and pre-wet the surface to facilitate spreading of the transfer ink containing the particles.

The upper slide (31) of the cartridge is made of Polydimethylsiloxane and has a window (35) surrounding the cylindrical volume receiving the technical liquid and the particles. It forms a hydrophobic barrier layer to prevent overflow of the technical liquid and the ink containing the particles. It is 10 μm thick.

A first intermediate slide (32) also has a window (36) and serves to secure the upper slide (31). It is made of 0.5 mm thick glass. It also acts as an overflow barrier.

A second intermediate slide (33) features a window (37) and two microfluidic channels (38, 39), one for supplying technical fluid and the other for drawing it in. It is made of Polydimethylsiloxane and is 160 μm thick.

The lower slide (34) is made of glass and is 0.5 mm thick. It has two holes (48, 49) at the inlet to the microfluidic channels of the slide (33). These two holes (48, 49) serve as inlet and outlet to the cartridge. The lower slide (34) is coated with a 20 nm layer of gold around the perimeter corresponding to the windows (35, 36, 37).

The assembly of these four stages (31 to 34) forms the donor substrate (30).

### Fluidic Connector

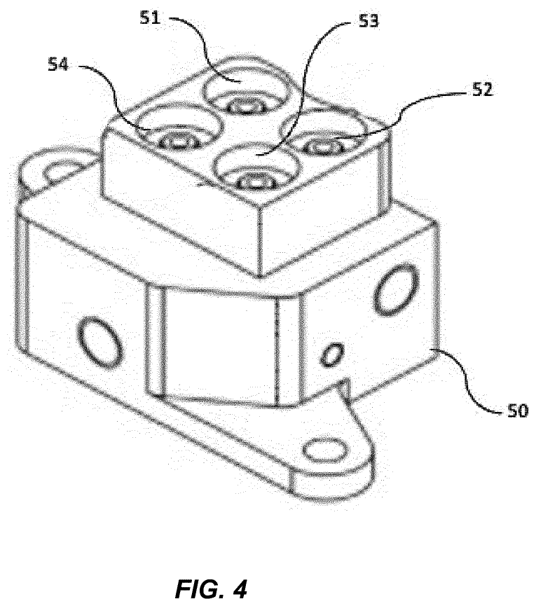

The donor substrate (30) is hooked onto a fluidic connector (50) shown in FIG. 4, featuring four channels (51 to 54) on its upper part. These four inlets/outlets (51 to 54) are fitted with lip seals or valves to ensure tightness. When the donor substrate (30) is placed on the fluidic connector (50), the holes (51, 53) will coincide with the recesses (48, 49) in the cartridge (50) and allow the technical fluid to enter and exit. These two channels enter from the side of the fluidic connector (50), and are connected by white pipes to pumps for circulating the technical fluid. Both pumps are connected to a reservoir containing the technical fluid. The particles to be transferred are then deposited on the film using a pipette carried by a robotic arm, for example. The other two holes (51, 54) in the fluidic connector (50) are connected to a vacuum pump and serve to press the donor substrate (30) onto the fluidic connector (50) by suction.

The fluidic connector (50) is mounted on a set of three micrometric screws along the three axes. The vertical micrometer screw is used to move the donor substrate (30) along the Z axis to position it on the laser focal plane. The two horizontal screws are used to move the donor substrate (30) along the X and Y axes, in order to target different areas of the cartridge, alternatively to use of the scanner.

Both fluidic pumps are computer-controlled via software. Several routines are recorded, including one for pre-wetting the cartridge. Preparing the technical liquid for printing is a two-step process. First, a pre-wetting film is applied to the bottom of the donor substrate (30). To achieve this, a volume of technical liquid is delivered via the first channel, while the pump in the suction channel is not switched on. In this way, the technical liquid will accumulate on the surface of the donor substrate (30), covering the entire surface, and the suction channel will then come into play while the supply of technical liquid is stopped. In this way, the thick film will become thinner, but the technical liquid will remain spread over the entire surface of the donor substrate (30), leaving the bottom well pre-wetted. Once this film is ready, a precise volume of ink containing the particles to be transferred is pipetted onto the donor substrate (30).

### Particle Transfer

The particle is ejected from the first cavitation bubble, which is much larger than in known LIFT solutions, due to the higher power and lower volume of liquid between the underside of the particle and the bottom of the donor substrate. The particle is ejected from the liquid on its own, using ballistic propulsion. The cavitation bubble bursts, expelling the particle upwards at high speed. After 150 μs, a polyethylene particle is about 3 mm high, that is, a speed of 20 m/s. It reaches the receiving substrate (40) almost dry and surrounded by residual liquid splashes.

Ejection of 250 μm collagen spheres is slower than for polyethylene beads. The particle reaches a height of 3 mm in 800 μs, compared with 100 μs for polyethylene. The transfer of cell spheroids behaves in a similar way to that described for collagen, since their shape and density are very similar. For example, the transfer of an IPSC spheroid (stem cells) also reaches 3 mm in height in 700 to 800 μs.

The base of the jet takes 100 μs to form with a sphere of collagen or IPSC. What's more, a single jet can be seen. The characteristic crown of the second jet is not present. Between 200 μs and 600 μs, the jet is formed by the IPSC spheroid at the top of the jet, and the carrier liquid forms the rest of the jet, still attached to the base. However, after 700 μs, the IPSC spheroid detaches from the jet, and the liquid falls back. The spheroid then continues its flight with little or no liquid, as with polyethylene. The jet is broken at a time similar to that of the bio-ink jet, that is, around 700 μs.

Unlike known LIFT solutions, all the cavitation energy is used to propel the particle, with no loss of energy to get it through and out of the layer of liquid around it, which can represent a mass greater than that of the particle itself. In addition, with the method described in the present disclosure, the particle undergoes very little fluid friction when ejected from the carrier liquid, due to the latter's viscosity.

### Transfer to the Receiving Substrate

Transfer takes place from the donor substrate (30), the cartridge containing the particles to be transferred, to a receiving substrate (40) consisting of a cell culture plate or glass slide.

The distance between the donor substrate (30) and the donor substrate (30) is critical. It must be greater than the time required to separate the liquid filament connecting the particle during its initial travel. Because of their porosity and/or hydrophilic nature, particles can entrain liquid, forming a kind of bond (capillary bridge) as long as the particle remains close to the surface of the liquid film, and breaking off at a certain distance depending on the characteristics of the liquid on the one hand and the particle on the other. Typically, this distance is a few millimeters, usually between 3 and 5 mm. The distance must also be limited so that the kinetic energy is sufficient to ensure that most particles reach the receiving substrate. A distance of between 3 and 10 mm is usually appropriate, but the person skilled in the art will be able to determine the optimum distance by observing, for example, with the TRI method mentioned above, the formation and breakage of the liquid filament forming during the trajectory of the particles. This distance can also be chosen to minimize the impact speed of the object on the receiver.

To cushion the impact of particles on the surface of the receiving substrate (40), one solution is to deposit an elastic coating, such as a 4 mg/ml collagen film, on its receiving surface. Collagen, like any other hydrogel, is more elastic than glass and will deform on impact, making the impact less violent for the transferred particle, which retains its original shape.

### Particle Displacement

The precision of the laser pulse is an important parameter. When the center of the pulse is offset in the horizontal XOY plane by more than 50 μm from the particle's centroid (or center of mass), the percentage of particles transferred decreases rapidly, and the localization accuracy decreases. Beyond 80 μm offset of the pulse from the particle center, for particles with an average diameter of 200 μm, the transfer fails.

The laser beam can be positioned by the scanner (15) or by positioning the donor substrate (30), for example, by acting on the micrometric screws that position the fluidic connector (50), or by low-power lasers pulses, for example, with less than half the power required for transfer, close to a particle to be moved in the horizontal XOY plane.

Advantages and disadvantages of a sacrificial layer The sacrificial layer ensures constant, reproducible absorption over the entire surface of the donor substrate. The ablated spots visible on the sacrificial layer can further be used to check that the laser is working properly.

However, the use of a sacrificial layer is costly and time-consuming, and above all means having to change the donor substrate as soon as the ablation rate becomes too high. However, for the manufacture of large numbers and/or sizes of tissues, the number of donor substrates required can quickly become very large, lengthening the production time and cost of the tissues.

The benefits of using a sacrificial-layer-free approach are therefore very significant for large-scale production applications, particularly in the clinical and industrial fields. Printing large objects such as spheroids using a system that works without a sacrificial layer is therefore particularly interesting for reducing manufacturing time and cost.

Solutions such as ultra-short impulse lasers (femtosecond/picosecond regime) or lasers working in the Mid-IR wavelength range (2.6 to 3.2 μm) are ideal for this purpose.

1. A method for transferring at least one object from a film of carrier liquid having a thickness e_{z} on a surface of a donor substrate toward a target substrate, in a vertical direction Z, the carrier liquid containing the at least one object to be transferred, the at least one object having dimensions (Dₓ, D_{y}, D_{z}), the method including exciting the liquid by applying localized energy to the liquid to form a local cavitation bubble at the at least one object, wherein the ratio D_{z}/e_{z} is greater than 0.5.

2. The method of claim 1, wherein the at least one object is a spheroid constituted by an aggregation of elementary biological cells.

3. The method of claim 1, wherein a value of each of Dₓ, D_{y}, D_{z} is greater than 100 μm.

3. The method of claim 1, wherein applying localized energy comprises focusing a laser at an interface between the surface of the donor substrate and the film of carrier liquid.

5. The method of claim 1, wherein applying localized energy comprises applying pulses of localized energy, each pulse of the pulses having an energy level based on a size of the at least one object.

6. The method of claim 1, wherein the target substrate is elastically deformable along the Z axis.

7. The method of claim 1, further comprising moving the at least one object in an XOY plane by applying an energy pulse with an energy at least two times lower than an energy required for transferring the at least one object to the target substrate.

8. The method of claim 1, wherein the at least one object comprises at least two objects spaced apart by a distance (d) less than 0.5 D_{xy}.

9. The method of claim 1, wherein the at least one object comprises a biological object.

10. The method of claim 1, further comprising repeating the method to manufacture a material, tissue or organ, wherein a volume fraction or volume density of biological objects transferred by propulsion in the printed material, tissue or organ is greater than 30%.

11. The method of claim 1, wherein the at least one object has a non-isotropic shape, and wherein applying localized energy comprises using several laser beams simultaneously.

12. A pulse energy deposition manipulation and transfer system, comprising:
an energy source configured to direct energy toward a material to be transferred, the material disposed on a donor substrate from which the material is manipulated and transferred by energy impulses applied by the energy source; and
a target receiving substrate for receiving the transferred material;
the donor substrate comprising a slide covered by the material to be transferred, constituted by a liquid carrier film containing the material, the material including transferable objects of size Dx, Dy, Dz, wherein the slide of the donor substrate is covered by the liquid carrier film, the liquid carrier film having a thickness (e) less than 2×Dz, where Dz is a dimension of the transferable objects in a direction perpendicular to the film, Dx, Dy being the orientation of the transferable objects in the plane of the film.

13. The system of claim 12, wherein the energy source is a laser.

14. The system of claim 12, wherein the slide is transparent or has low absorption at a wavelength of the energy directed from the energy source.

15. The system of claim 12, further comprising an opto-mechanical system for directing a laser spot with respect to a centroid or a center of mass of an object of the transferable objects.

16. The system of claim 12, further comprising an intelligent object detection system, and means for automating placement of the material on the donor substrate and

17. The system of claim 12, wherein the donor substrate is covered by a sacrificial layer with high absorption/conduction properties for laser or electric field energy deposition.

18. The system of claim 12, wherein the receiving substrate is not covered by a layer with high laser absorption properties to initiate the propulsion process, absorption being achieved directly by the liquid layer between the object and the donor substrate.

19. The tosystem of claim 12, further comprising an optical viewing/detection system for locating and targeting the transferable objects, compatible with a random distribution of transferrable objects on the donor substrate.

20. The system of claim 12, wherein the donor substrate is arranged below the receiving substrate.

21. The system of claim 12, further comprising at least one other printing means comprising extrusion, inkjet, and/or LIFT to manufacture material or tissue with different components.

22. The equipment system of claim 12, further comprising means for delivering several laser beams simultaneously to a transferrable object of the transferrable objects when the transferrable object has a non-isotropic shape.

23. The tosystem of claim 12, wherein the donor substrate comprises micro-wells in which the transferrable objects are arranged.
